(19) United States
(12) Patent Application Publication
(10) Pub. No.: US 2026/0228647 A1
(43) Pub. Date: Aug. 6, 2026

(54) a System and method to plan and book hotels utilizing artificial intelligence

(71) Applicant: Zenvoya, Inc., Mclean, VA (US)

(72) Inventor: Surendra Goel, Mclean, VA (US)

(21) Appl. No.: 19/459,373

(22) Filed: Jan. 26, 2026

Related U.S. Application Data
(60) Provisional application No. 63/751,390, filed on Jan. 30, 2025.

(51) Int. Cl. G06Q 10/02; G06Q 50/12

(52) U.S. Cl. CPC G06Q 10/02; G06Q 50/12

(57) ABSTRACT

A computer-implemented method to plan and book hotels utilizing artificial intelligence from unstructured user input with a language model, the method comprising: receiving, at a computer system, an input hotel query reflecting a user intention; wherein an artificial intelligence model has been trained based on user data of a user’s hotel preferences; analyzing the input hotel query using the trained artificial intelligence model; generating possible hotels in terms of dates, based on the input hotel query, external context, hotel attributes (structured and unstructured; see appendix hotel attributes) and the user’s hotel preferences; wherein the artificial intelligence utilized is either machine learning, deep learning or neural networks; wherein the artificial intelligence model utilizes a probabilistic model; wherein the language model may be either a large language model or a small language model; wherein there are several additional dimensions by which possible hotels are generated.

### FIELD OF THE INVENTION

The present invention relates to a System and method to plan to book hotels utilizing artificial intelligence (“AI”).

### BACKGROUND

The background description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients or properties such as concentration, reaction conditions, and so forth, used to describe and claim certain embodiments of the invention are to be understood as being modified in some instances by the term “about.”

Accordingly, in some embodiments, the numerical parameters set forth in the written description and attached claims are approximations that can vary depending upon the desired properties sought to be obtained by a particular embodiment.

In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meanings of “a,” “an,” and “the” include plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. "such as”) provided with respect to certain embodiments herein is intended merely to better illuminate the invention and does not pose a limitation on the scope of the invention otherwise claimed.

No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Today, the search for hotels online is Boolean, in the sense that a customer picks options and sees results that fit those options. For example, if a customer picks a city to stay in, as well as checking and checkout dates, then the results are restricted to what’s available in those fields.

The customer is unaware of alternative cities or dates that might be preferential. The customer is also unaware of other possibilities that might arise with fewer field restrictions.

### SUMMARY

The present invention seeks to address one or more of the above-mentioned disadvantages or provide a useful alternative.

The present invention makes the customer aware of additional possibilities that the customer might not otherwise see in a Boolean search. Through the use of artificial intelligence, including machine learning, deep learning and neural networks, the present invention can make the customer aware of alternative hotels, as well as all possibilities associated with limited fields. For example, the customer might only enter location hotels without dates, and the results could include numerous dates, optionally listed in order of lowest price to highest price. The results could further include guest type, as in adult or child; number of beds; nearby airports; room class, as in economy, premium, business, or first class; ability to get a partial refund; ability to get a full refund; ability to choose a view; time of check-in; time of check-out; whether breakfast is included; whether the user is paying in cash or using points; whether any discounts apply; user data of a user’s hotel preferences, as well as hotel preferences based on metadata of that user, such as location of the user, time of the hotel travel query, income level, hotel location, hotel availability and variables relating to hotels. These results might give the customer a broader sense of the market for what hotel they want to book, as opposed to their initial narrow assumption.

In one embodiment of the present invention, the present invention utilizes synthetic data for training data and utilizes a probabilistic model instead of a Boolean model. A probabilistic model can result in improved results when input is in natural language format, as it would be here when a user enters desired hotel information. A probabilistic model can also create better results when the data varies, which is true regarding hotels, because hotels are constantly changing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

Many aspects of the present disclosure can be better understood with reference to the attached drawings. The components in the drawings are not necessarily drawn to scale, with emphasis instead being placed upon clearly illustrating the principles of the disclosure. Moreover, in the drawings, like reference numerals designate corresponding parts throughout several views.

FIG. 1 is a drawing of a flow chart according to various embodiments of the present disclosure.

FIG. 2 illustrates an example environment 1 in which examples of the disclosure operate, to provide an overview of components of the disclosure.

FIG. 3 illustrates an example hotel query 400 submitted to the LLM 301 to generate possible hotels in terms of dates from unstructured user input, for example in the form of natural language query, in the examples herein.

FIG. 4 illustrates a process of training a model to generate possible hotels and hotel data that are responsive to the user’s hotel query.

FIG. 5 illustrates an example process of forming the training data set 110 in more detail.

### DETAILED DESCRIPTION

Various embodiments of the present disclosure relate to providing a System and method to plan to book hotels utilizing artificial intelligence. Examples of the disclosure relate to generating possible hotels in terms of dates, from unstructured user input, for example in the form of natural language query. Additional variables relating to possible hotels include as specified in the appendix HOTEL ATTRIBUTES. More variables include the ability to get a partial refund, the ability to get a full refund, and whether any discounts apply. It is possible that more variables could be discovered and analyzed over time.

Recently, Large Language Models (“LLMs”) employing a transformer architecture have been developed. Such LLMs are trained on a very large quantity of data, comprising a wide variety of diverse datasets. For example, GPT-3 (Generative Pre-trained Transformer 3) developed by OpenAI® has 175 billion parameters and was trained on 499 billion tokens. BERT (Bidirectional Encoder Representations from Transformers), developed by Google®, is an example of another LLM.

The diverse training and large size of LLMs has led to some emerging properties and characteristics that were not possible with previous models. One of these aspects is the concept of using natural language prompts to ask the LLM to solve a task in a general way. These often fall into the category of zero-shot, one-shot or few-shot learning, with the “shots” being the number of labelled examples provided to the LLM as part of the natural language prompt.

In another embodiment of the present invention, a small language model (“SLM”) may be used instead of a LLM. A SLM may be beneficial because of a lower cost to run because less computational power is required. A SLM may also run more quickly because it utilizes less parameters than an LLM. A SLM may also be run offline because it does not require cloud computing resources that a LLM requires. A SLM may also be more fine-tuned to hotel queries versus a LLM, which might be more generalist. In any embodiment utilizing an LLM, an alternate embodiment utilizing an SLM is possible. Also, any embodiment may be combined with one or more other embodiments.

In one embodiment of the present invention, a hyperparameter is finely tuned so as to provide the most relevant results to a consumer regarding possible hotels the consumer is interested in booking. The results can be ranked by price, from low to high or high to low, or by other factors, such as the nearest airport, or date, or having a view or not, or having certain types of food available, or perhaps even likelihood of crime in that area.

In one embodiment of the present invention, training data will be synthetic data that is created in order to provide good results to consumers searching for hotels. An initial model will be a probabilistic model that is a mathematical representation of a random phenomenon that uses probabilities to predict future outcomes. This is in contrast to a Boolean model, in which retrieval is based on whether or not the documents contain the query terms and whether they satisfy the Boolean conditions described by the query. The probabilistic model will have some amount of personalization, such that each consumer will have a customized experience while searching for hotels. A user may have their previous hotels inputted, or previous hotel searches inputted, or both, such that the probabilistic model can learn what the user prefers in terms of hotels and variables relating to hotels.

Accordingly, the disclosure relates to generating possible hotels in terms of dates, hotel star rating, refundable, user ratings, and amenities based on a prompt for an LLM, the prompt including one or more examples (or “shots”) and additional query metadata (e.g. table schemas and an indication of relevant tables). The shots and query metadata are generated by a trained machine learning model. The resulting prompt can then be passed to the LLM, which returns possible hotels in terms of dates, hotel location, star rating, refundable and user ratings. In some examples, multiple prompts are generated and passed to the LLM, and a selection is made from the resulting possible hotels. The use of the trained machine learning model to select the shots and query metadata results in accurate possible hotels closely corresponding to the intent of the original user input.

In one example, the machine learning model that generates the shots (i.e. the “one shot” or “few-shots”) for the prompt is trained using a probing procedure, in which probe prompts are generated from a training set. The probe prompts include various permutations of example shots, which are passed to the LLM. The outcome of each probe prompt is compared to a known ground truth to generate a score. The model is then trained to select an example shot, or in the examples where multiple shots are used, select multiple shots. For example, the model can be trained to rank the example shots and select shots for inclusion in a prompt accordingly. The query metadata is also learned from the training set.

LLMs provide general application programming interfaces (APIs) for performing tasks including completion (i.e. completing a prompt to provide an answer to the hotel query). The APIs and to some extent the LLMs are black boxes, and it can be difficult to ascertain why the LLM returns the results it does, making it difficult to reliably curate prompts to return results in a predictable and expected way. The use of the probing procedure results in a trained machine learning model that takes into account the characteristics of the LLM.

In one embodiment of the present invention, machine learning will be utilized. In another embodiment, neural networks will be utilized.

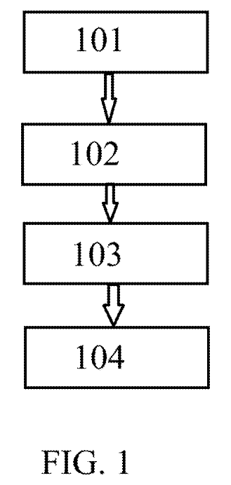

FIG. 1 illustrates a flow chart according to various embodiments of the present disclosure. The system 100 includes a processor 101 and storage 102. The processor 101 is configured to execute instructions stored in the storage 102 in order to carry out the training methods discussed herein. The storage 102 also stores a training data set 110. The training operations of the system 100 are represented by training module 120, which will be discussed in more detail below.

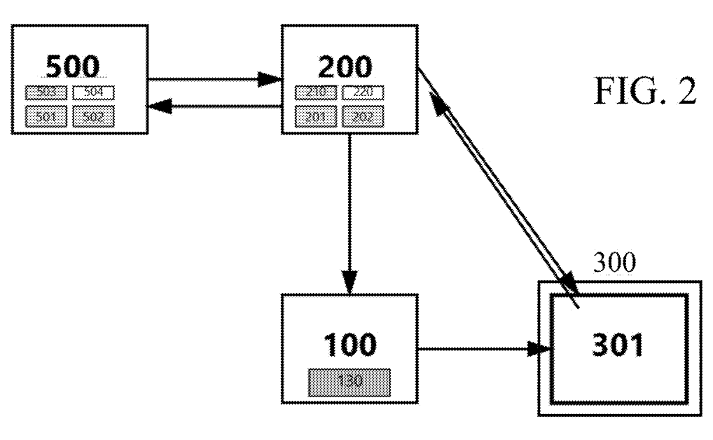

FIG. 2 illustrates an example environment 1 in which examples of the disclosure operate, to provide an overview of components of the disclosure.

The environment 1 includes a large language model (LLM) 301. The LLM 301 is a trained language model, based on the transformer deep learning network. The LLM 301 is trained on a very large corpus (e.g. in the order of billions of tokens) and is a generative model that can generate text or data in response to receipt of a prompt. Particularly, the LLM 301 is able to generate possible hotels that is responsive to the hotel query includes possible hotels in terms of dates, hotel star rating, refundable, user ratings, and amenities in response to a prompt. These possible hotels can also be based on data from hotels, past user queries, past user hotel bookings and synthetic data based on all of these factors as well as other possible factors.

An example of a suitable LLM 301 is the OpenAI Codex model (https://openai.com/blog/openai-codex/). The Codex model is a version of the GPT-3 model, fine-tuned for use in code generation. However, a variety of LLMs 301 may be employed in the alternative, which may or may not be specifically tuned for code generation. The techniques discussed herein effectively learn the characteristics of the underlying LLM 301 and thus are particularly apt for use with different LLMs 301.

The LLM 301 operates in a suitable computer system 300. For example, the LLM 301 is stored in a suitable data center, and/or as part of a cloud computing environment or other distributed environment. The LLM 301 is accessible via suitable APIs, for example over a network connection.

The environment 1 includes a system 100 configured to train a machine learning model 130 to generate elements for inclusion in a prompt for input to the LLM 301. The prompt includes a user query, discussed in more detail below, which is converted to a hotel query by the LLM 301.

The system 100 for training the machine learning model 130 comprises any suitable computer system. In one example, the system 100 may be a suitable high-performance computer or computer cluster. In other examples, the system 100 may be a server computer, for example located in a data center. Equally, the system 100 may be a desktop or laptop computer or the like.

The environment 1 further includes a system 200 configured to generate a prompt for the LLM 301 using the trained model 130. In other words, the system 200 carries out the inference time activities discussed herein. The system 200 may also submit the prompt to the LLM 301 to generate possible hotels. By corresponding, it is meant that resulting possible hotels are reflective of the intention of the user inputting the hotel query. In other words, input into the trained model, when executed, would return results responsive to the user's input hotel query.

The system 200 includes a processor 201 and storage 202. The processor 201 is configured to execute instructions stored in the storage 202 in order to carry out the inference methods discussed herein. The storage 202 also stores the trained model 130. The inference operations of the system 200 are represented by inference module 210 and will be discussed in more detail below.

The system 200 also includes an access interface 220. In one example, the access interface 220 may take the form of a suitable API, for receiving the user hotel query from a user device (500, discussed below), and returning the corresponding possible hotels and data relating to hotels. In another example, the access interface 220 is a web interface, configured to serve web pages via which a user may input a user hotel query and receive the corresponding possible hotels and data relating to hotels.

The environment further includes a system 500, which is a user system operated by an end user. The system 500 includes a processor 501 and storage 502. The system 500 has a user interface 503, which is configured to receive user input and display data to the user. The system 500 also includes a query executor 504, which is configured to receive and execute a hotel query. The user may interact with system 500 via the user interface 503, to input a user hotel query. In some examples, the system 500 displays the corresponding hotel query on the user interface 503.

In some examples, the systems 100 and 200 are the same system. That is to say, the same system may be used to train the model and for inference. In some examples, the system 200 and 500 are the same system, such that the system carrying out the inference is the same system including the query executor 504 and receiving user input.

The overall environment 500: User system with components 501, 502, 503, 504. 200: Inference system with components 201, 202, 210, 220. 100: Training system containing model 130. 301: The LLM within system 300.

Synthetic data may be used to train the LLM. Synthetic data are artificially generated data not produced by real-world events. Typically created using algorithms, synthetic data can be deployed to validate mathematical models and to train machine learning models.

Data generated by a computer simulation can be seen as synthetic data. This encompasses most applications of physical modeling, such as music synthesizers or flight simulators. The output of such systems approximates the real thing but is fully algorithmically generated.

Synthetic data is generated to meet specific needs or certain conditions that may not be found in the original, real data. One of the hurdles in applying up-to-date machine learning approaches for complex scientific tasks is the scarcity of labeled data, a gap effectively bridged by the use of synthetic data, which closely replicates real experimental data. This can be useful when designing many systems, from simulations based on theoretical value, to database processors, etc. This helps detect and solve unexpected issues such as information processing limitations. Synthetic data are often generated to represent the authentic data and allows a baseline to be set. Another benefit of synthetic data is to protect the privacy and confidentiality of authentic data, while still allowing for use in testing systems.

A more complicated dataset can be generated by using a synthesizer build. To create a synthesizer build, first use the original data to create a model or equation that fits the data the best. This model or equation will be called a synthesizer build. This build can be used to generate more data. Constructing a synthesizer build involves constructing a statistical model. In a linear regression line example, the original data can be plotted, and a best fit linear line can be created from the data. This line is a synthesizer created from the original data. The next step will be generating more synthetic data from the synthesizer build or from this linear line equation. In this way, the new data can be used for studies and research, and it protects the confidentiality of the original data.

There are a variety of filters that the present invention can use to output results, such as by price, lowest to highest or vice versa, by size of room, smallest to largest or vice versa, in a date range, earliest to latest, or vice versa, by brand, by certain food availability, or other fields that a user might create. Hotels might be excluded or specifically preferred, as may other factors, such as cleanliness and hygiene, or perhaps other qualities of a hotel that have yet to be determined.

In another embodiment of the present invention, the invention eliminates post filters and instead lets users refine their preferences. The invention’s goal is for a user to see their expected results in the first 10 results (top 10 results) or less.

In another embodiment of the present invention, the invention takes multiple steps to accomplish its goal. A first step 101 is a user makes a request in natural language. A second step 102 is that the invention parses data from the user’s request. A third step 103 is the invention generates results from multiple sources, wherein these sources include hotel data from the different hotels. A fourth step 104 is that the invention feeds user input and data returned from multiple sources into an artificial intelligence system. The artificial intelligence system returns results closer to the user’s expectations, as in closer than what might have returned without an artificial intelligence analysis. The artificial intelligence system is trained on synthetic data using either machine learning or neural networks.

Training data may be received from a remote database or a local database, constructed from various subsets of data, or input by a user. The training data may be used in its raw form for training a machine-learning model or pre-processed into another form, which can then be used for training the machine learning model. For example, the raw form of the training data may be smoothed, truncated, aggregated, clustered, or otherwise manipulated into another form, which can then be used for training the machine-learning model. In embodiments, the training data may include hotel information, historical hotel information, and/or information relating to hotels and searches. The hotel information may be for a general population and/or specific to a user and user account. The machine learning model may be trained to identify optimal searches and search results by measuring the effectiveness of prompts at achieving a good selection of hotels or a preferred selection of hotels, wherein the effectiveness may be measured in one embodiment by time to final decision by a consumer.

A machine-learning model may be trained using the training data. The machine-learning model may be trained in a supervised, unsupervised, or semi-supervised manner. In supervised training, each input in the training data may be correlated to a desired output. The desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model must find structure in the inputs on its own. In semi-supervised training, only some of the inputs in the training data are correlated to desired outputs.

The machine-learning model may be evaluated. For example, an evaluation dataset may be obtained, for example, via user input or from a database. The evaluation dataset can include inputs correlated to desired outputs. The inputs may be provided to the machine-learning model and the outputs from the machine-learning model may be compared to the desired outputs. If the outputs from the machine-learning model closely correspond with the desired outputs, the machine-learning model may have a high degree of accuracy.

For example, if 90% or more of the outputs from the machine-learning model are the same as the desired outputs in the evaluation dataset, e.g., the current communication exchange information, the machine-learning model may have a high degree of accuracy. Otherwise, the machine-learning model may have a low degree of accuracy. The 90% number may be an example only. A realistic and desirable accuracy percentage may be dependent on the problem and the data.

In some examples, if the machine-learning model has an inadequate degree of accuracy for a particular task, then the machine-learning model may be further trained using additional training data or otherwise modified to improve accuracy. If the machine-learning model has an adequate degree of accuracy for the particular task, the process can be finalized.

At this point in time, the machine learning model(s) have been trained using a training data set to process a search query through hotel data in order to determine optimal results based on a customer’s interests and desires and sort them in an optimal way that utilizes a probabilistic model.

In an alternative embodiment of the present invention, the present invention may utilize 1 or more neural networks. Neural networks are selected from a group consisting of feed forward neural networks, radial basis function neural networks, self-organizing neural networks, Kohonen self-organizing neural networks, recurrent neural networks, modular neural networks, artificial neural networks, physical neural networks, multi-layered neural networks, convolutional neural networks, a hybrids of a neural networks with another expert system, auto-encoder neural networks, probabilistic neural networks, time delay neural networks, convolutional neural networks, regulatory feedback neural networks, radial basis function neural networks, recurrent neural networks, Hopfield neural networks, Boltzmann machine neural networks, self-organizing map (“SOM”) neural networks, learning vector quantization (“LVQ”) neural networks, fully recurrent neural networks, simple recurrent neural networks, echo state neural networks, long short-term memory neural networks, bi-directional neural networks, hierarchical neural networks, stochastic neural networks, genetic scale RNN neural networks, committee of machines neural networks, associative neural networks, physical neural networks, instantaneously trained neural networks, spiking neural networks, dynamic neural networks, cascading neural networks, neuro-fuzzy neural networks, compositional pattern-producing neural networks, memory neural networks, hierarchical temporal memory neural networks, deep feed forward neural networks, gated recurrent unit (“GRU”) neural networks, auto encoder neural networks, variational auto encoder neural networks, de-noising auto encoder neural networks, sparse auto-encoder neural networks, Markov chain neural networks, restricted Boltzmann machine neural networks, deep belief neural networks, deep convolutional neural networks, deconvolutional neural networks, deep convolutional inverse graphics neural networks, generative adversarial neural networks, liquid state machine neural networks, extreme learning machine neural networks, echo state neural networks, deep residual neural networks, support vector machine neural networks, neural Turing machine neural networks, and holographic associative memory neural networks.

These one or more neural networks may be trained in the same way as the machine learning model was trained, shown above. Or the one or more neural networks may be trained in accordance with its own unique style, pattern or algorithm.

In one embodiment of the present invention, graphical processor units (“GPUs”) are utilized in order to maximize speed and potential of the artificial intelligence system, whether it uses machine learning or neural networks. Either arrays of GPUs or cloud servers of GPUs or supercomputers of GPUs may be utilized to maximize performance of the artificial intelligence system of the present invention.

In another embodiment of the present invention, post filters are used so that the user can use faceted filters to remove certain results from an original set of results. Such post filters can be strings, words or hashtags. Such filters can be regarding price, from low to high or high to low, or by other factors, such as nearest airport, or date, or size of room, or whether certain types of food are available in the hotel or nearby, or cleanliness and hygiene. This can be useful in order to narrow what the user has to look through individually and can further customize results so that the user finds hotels more easily on a first or second search attempt.

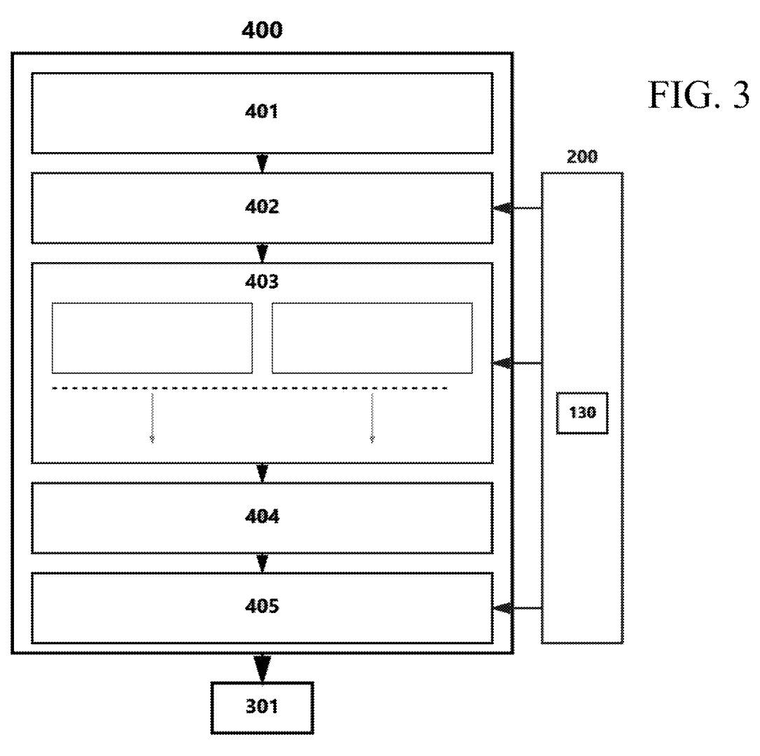

FIG. 3 illustrates the example hotel query 400 submitted to the LLM 301 to generate possible hotels in terms of dates, guest type, as in adult or child; number of beds, nearby airports, room class, as in economy. premium, business, or first class; ability to get a partial refund; ability to get a full refund; ability to choose a view, time of check-in; time of check-out; whether breakfast is included; whether the user is paying in cash or using points; whether discounts apply; user data of a user's hotel preferences, as well as hotel preferences based on metadata of that user, such as location of the user, time of hotel travel query, income level, hotel location, hotel availability and variables relating to the hotels, from unstructured user input, for example in the form of natural language query, in the examples herein. The hotel query 400 includes a preamble 401 that the LLM 301 should generate possible hotels based on a variety of variables based on a hotel query. In one example, the preamble 401 is static. That is to say, it may be predetermined, rather than being generated dynamically. In other examples, the preamble 401 is dynamically generated-for example some variability may be introduced to the preamble 401 by selecting it (or elements of it) from a plur402ality of predetermined options, for example by random chance or according to some other distribution. The hotel query 400 also includes table schema data 402. This is an example of query metadata, which is information derived from the input query. The query metadata is extra information acting as a hint or pointer to the LLM 301 as to the possible hotels to be generated.In the example of FIG. 3, the table schema data 402 lists a particular table and particular columns that are relevant to the possible hotels to be generated. The hotel query 400 also includes shots 403, which are example input hotel queries and corresponding possible hotels. In the example shown, the prompt includes two shots 403, the shots 403 being separated by a line of hash symbols acting as a separator. The hotel query 400 further includes the input hotel query 404, for which the corresponding possible hotels are sought. Finally, the hotel query 400 includes table intent data 405, which is another example of query metadata. The table intent data 405 states which tables the resulting possible hotels should use.

The shots 403 and the query metadata 402, 405 are generated dynamically by the system 200 using the trained model 130. The hotel query 400 shown in FIG. 3 is merely an example of the structure of a suitable prompt to assist understanding of the example systems and methods discussed herein. The arrangement of the elements of the hotel query 400 and the number of shots 403 included may vary. Furthermore, other types of query metadata may be included in the hotel query 400. In some examples, the query metadata includes an indication of the length or complexity of the resulting possible hotels. For example, the query metadata may include a statement indicating that the resultant possible hotels is likely to be short (e.g. under a certain number of lines) or long (e.g. over a certain number of lines). The query metadata may give an indication of the types of statements to be included in the possible hotels.

401: Preamble, 402: Table schema data (query metadata), 403: Shots section with two example shots separated by a dashed line, 404: Input hotel query, 405: Table intent data (query metadata). Black arrows indicating the sequential flow within the prompt, System 200 (blue box on right) with model 130 generating the dynamic elements (402, 403, 405) shown by arrows. The complete query 400 flows down to LLM 301 at the bottom.

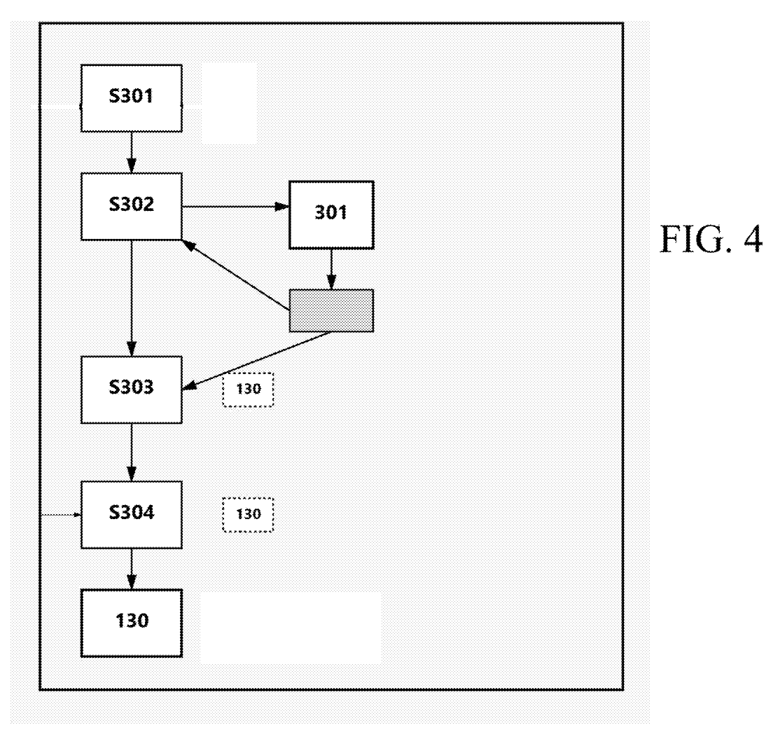

FIG. 4 illustrates a process of training a model to generate possible hotels and hotel data that are responsive to the user’s hotel query. The process may be carried out by the training system 100. In step S301, the process includes forming a training data set for training the model 130. The training data set can include manually labelled training data and/or synthetically generated examples. In step S302, the process includes probing the LLM 301 with probe prompts generated from the training data. The probe prompts include shots selected from the training data. By assessing the response of the LLM 301 to different probe prompts including different selections of shots, a ranking of the usefulness of the shots is obtained. In step S303, the process includes training the model 130 to select shots for inclusion in a prompt using the ranking obtained in step S302. In step S304, the process includes training the model 130 to generate query metadata for inclusion in a prompt using the training data. The process results in the trained model 130, which is configured to generate shots and query metadata for a prompt for submission to the LLM 301.

System 100: S301: Forms training data set (shown with stacked rectangles); S302: Probes LLM 301 with prompts, receives responses, and creates ranking; S303: Trains model 130 (dashed box) to select shots using the ranking; S304: Trains model 130 (dashed box) to generate query metadata using training data; Final 130: The fully trained model with its output capabilities (shown with gray rectangles).

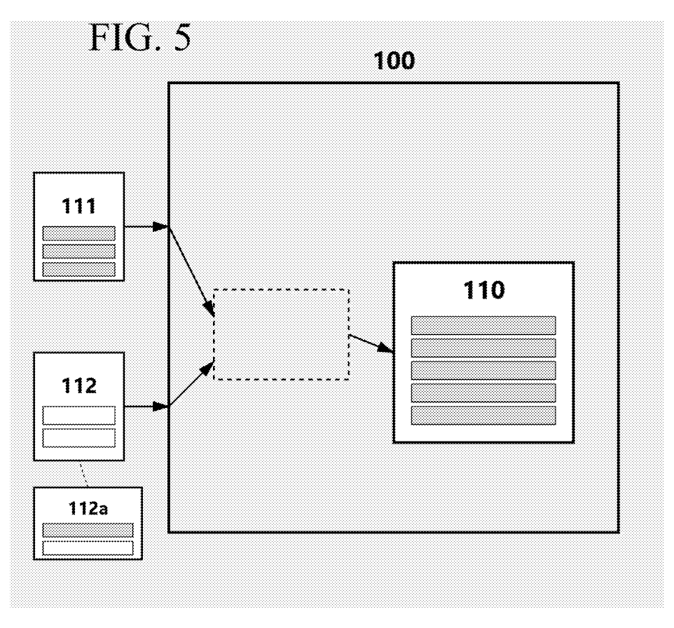

FIG. 5 illustrates an example process of forming the training data set 110 in more detail. The system 100 is provided with an initial training data set 111. The initial training data set 111 comprises example prompts similar to the prompt illustrated in FIG. 3, which are ground truth examples of prompts for a particular input query. The system 100 also is provided with a set of hotel queries 112, each query having a corresponding description. The description explains the purpose of the corresponding hotel query. An example hotel query and description 112 is shown in FIG. 5.

In one example, the hotel queries and descriptions are manually created. For example, they may be harvested from a user’s browser history, from online records, from hotel records or other similar databases and the like. In other examples, the hotel queries and description may be synthetically generated, for example by using techniques similar to that discussed in Chris Alberti, Daniel Andor, Emily Pitler, Jacob Devlin, and Michael Collins, 2019, Synthetic QA Corpora Generation with Roundtrip Consistency, which is hereby incorporated by reference. In Proceedings of the 57th Annual Meeting of the Association for Computational Linguistics, pages 6168-6173, Florence, Italy, Association for Computational Linguistics, which is hereby incorporated by reference.

The initial training set 111 and hotel query set 112 are used to generate example user queries corresponding to the hotel queries in the query set 112. Particularly, examples from the initial training set 111 are used as shots in a prompt 113 for generating the corresponding user query. Once generated, each prompt 113 is supplied to a LLM 114. In one example, the LLM 114 is an LLM intended for natural language generation, such as the Davinci GPT-3 model provided by OpenAI. The LLM 114 accordingly returns synthetic user queries 115 corresponding to the hotel queries in the hotel query set 112.

This approach allows a relatively small initial training data set 111 including user queries and corresponding hotel queries to be expanded using a larger labelled data set of hotel queries 112 accompanied by textual descriptions. In addition, by varying the shots included in the prompts 113, a plurality of different-styled user queries that can be generated that correspond to the same underlying hotel queries. This is on the basis that the LLM 114 will respond with different variations (e.g. different syntactic structure or writing style) of the user queries dependent on the shots included in the prompt. The result of this part of the process is a corpus comprising hotel queries, descriptions and corresponding user queries.

In order to further expand the training data, the synthetic queries are then augmented. In other words, natural language processing techniques or tools are used to generate further queries that substantially correspond in meaning to the queries 115. In one example, the user queries are back-translated to generate new queries. Backtranslation is the process of translating the query from English into a different language and back again, using suitable trained machine translation models. The result of the backtranslation can simply be taken as a new query, or the result can be combined with the original query to expand the query. The queries can be back-translated via a variety of different languages to generate more queries. The back-translated and original queries 115 are augmented to generate augmented queries 116 by replacing one or more words of the queries with synonyms using thesauruses or word embedding models, or by inserting words in the queries based on suitable word embedding models. An example library suitable for carrying out this data augmentation is the NLP Augmentation library (Edward Ma, see https://github.com/makcedward/nlpaug). This results in a relatively large corpus 110 of example natural language queries, each corresponding to a hotel query.

111: Initial training data set with example prompts (shown as stacked gray rectangles); 112: Set of hotel queries with descriptions; 112a: A detailed example showing a query (gray) paired with its description (white); 100: System boundary containing a processing area (dashed box); 110: The resulting training data set with combined data (multiple gray rectangles). The arrows show how data from 111 and 112 flow into system 100's processing area, which then produces the final training data set 110.

In another embodiment of the present invention, AI agents are utilized. AI agents (also referred to as compound AI systems or agentic AI) are a class of intelligent agents distinguished by their ability to operate autonomously in complex environments. Agentic AI tools prioritize decision-making and possess several key attributes, including complex goal structures, natural language interfaces, the capacity to act independently of user supervision, and the integration of software tools or planning systems. Their control flow is frequently driven by large language models (LLMs). Agents also include memory systems for remembering previous user-agent interactions and orchestration software for organizing agent components. In this embodiment, AI agents can be utilized to find and book hotels.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them.

The term “processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Generally, a processor will receive instructions and data from a read-only memory or a random access memory or both. The essential elements of a computer are a processor for performing actions in accordance with instructions and one or more memory devices for storing instructions and data. Generally, a computer will also include or be operatively coupled to receive data from or transfer data to, or both, one or more mass storage devices for storing data, e.g., magnetic, magneto-optical disks, or optical disks. However, a computer need not have such devices.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface r a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

From the foregoing, it will be appreciated that specific embodiments of the invention have been described herein for purposes of illustration, but that various modifications may be made without deviating from the spirit and scope of the invention. Accordingly, the invention is not limited except as by the appended claims.

### APPENDIX HOTEL ATTRIBUTES

### A. Structured Hotel Attributes

### 1. Stay Details

Check-in date

Check-out date

Number of nights

Number of adults

Number of children

Ages of children

Number of rooms

Room type (single, double, suite, etc.)

Bed type (king, queen, twin, sofa bed)

### 2. Pricing & Payment

Base nightly rate

Taxes and fees

Total price

Refundability (non- Refundable, partially refundable, fully refundable)

Deposit required (yes/no, amount)

Payment method (cash, credit card, loyalty points)

Points cost (if applicable)

### 3. Room Features

Room size (sq ft / sq meters)

View type (city, ocean, garden, pool, mountain)

Floor level

Balcony (yes/no)

Kitchenette / full kitchen

Workspace / desk

Bathtub vs. shower

Accessible room (ADA compliance)

In-room safe

Minibar

Coffee maker type

TV size and type

Wi-Fi availability and speed tier

### 4. Hotel Property Attributes

Star rating

Brand / chain affiliation

Property type (hotel, resort, apartment, hostel, boutique)

Number of floors

Number of rooms

Year built Year renovated

Check-in time

Check-out time Parking availability (self, valet)

EV charging availability

Pet policy (allowed/not allowed, weight limit, fee)

### 5. Amenities Structured

Pool (indoor/outdoor)

Fitness center

Spa Sauna / steam room

Business center

Meeting rooms

Restaurant(s)

Bar / lounge

Breakfast included (yes/no)

Airport shuttle

Laundry service

24-hour front desk

Room service

Concierge

Luggage storage

Free Wi-Fi

Paid Wi-Fi

Housekeeping frequency

Kids club

On-site convenience store

### 6. Location Attributes

Address

Latitude / longitude

Distance to city center

Distance to airport

Distance to public transit

Neighborhood classification

Proximity to landmarks (structured distances)

### 7. Accessibility Attributes ADA

Roll-in shower

Grab bars

Accessible parking

Elevator access

Visual alarms

Braille signage

Wheelchair-accessible paths

### 8. Loyalty Program Attributes

Loyalty tier benefits

Points earned per stay

Points redemption availability

Elite perks (upgrades, breakfast, late checkout)

### 9. Review-Based Structured Metrics

Cleanliness score

Staff score

Location score

Value score

Comfort score

Amenities score

Overall rating

Number of reviews

Review recency distribution

### B. Unstructured Hotel Attributes

### 1. Atmosphere & Vibe

“Quiet rooms” or “not near the elevator”

“Romantic vibe”

“Trendy / modern feel”

“Cozy / boutique atmosphere”

“Not outdated”

“Good for couples”

“Good for solo travelers”

“Relaxing ambiance”

“Not a party hotel"

“Energetic / social vibe”

### 2. Location Nuances Beyond Coordinates

“Walkable to restaurants”

“Safe neighborhood”

“Near public transit”

“Near a conference center”

“Near a specific landmark”

“Good for sightseeing”

“Away from tourist crowds”

“Near a running trail / park”

### 3. Room Experience Soft Attributes

“Soft pillows” or “firm pillows”

“Good water pressure”

“Quiet air conditioning”

“No carpet”

“Renovated rooms”

“Large bathrooms”

“Good natural light"

“Blackout curtains”

“No connecting door”

“High floor with a view”

“Not facing the street”

### 4. Food & Beverage Preferences

“Good room service”

“Healthy breakfast options”

“Vegan-friendly”

“Late-night food options”

“Good hotel bar”

“Coffee shop on site”

“Local cuisine nearby”

### 5. Service Quality & Staff

“Friendly staff”

“Fast check-in”

“Good concierge”

“Responsive housekeeping”

“Good for long stays"

“Good for business travelers”

### 6. Family-Oriented Requests

“Kid-friendly staff”

“Cribs available”

“Quiet rooms for naps”

“Suites with doors”

“Kitchenette for families”

### 7. Pet-Related Nuances

“Pet-friendly with no weight limit”

“Good outdoor space for dogs”

“Nearby dog parks”

“No pet fee”

### 8. Amenities

“Good gym with free weights”

“Nice pool area”

“Spa quality”

“Fast Wi-Fi”

“Coworking-friendly lobby

“Good business center”

“EV chargers in the garage”

### 9. Sustainability & Wellness

“Eco-friendly hotel”

“No single-use plastics”

“Air purifiers in rooms”

“Non-toxic cleaning products”

“Allergy-friendly rooms”

### 10. Reputation & Social Proof

“Highly rated for cleanliness”

“Good for digital nomads”

“Popular with locals”

“Not too touristy”

“Good reviews for comfort”

### 11. Experience-Based Requests

“Best for honeymoon

“Best for business travel”

“Best for a weekend getaway”

“Good for long-term stays”

“Good for remote work

1. A computer-implemented method to plan and book hotels utilizing artificial intelligence from structured and unstructured user input with a language model, the method comprising:
receiving, at a computer system, an input hotel query reflecting a user intention;
wherein an artificial intelligence model has been trained based on user data of a user’s hotel preferences, hotel availability and many attributes relating to hotels;
wherein artificial intelligence is used to understand the user intent to find the best semantic matches to the user input, external context, hotel attributes and the available hotel inventory;
analyzing the input hotel query using the trained artificial intelligence model; and
generating possible hotels in terms of dates, based on the input hotel query, external context, hotel attributes (structured and unstructured; see appendix hotel attributes) and the user’s hotel preferences.

2. The method of claim 1, further comprising:
wherein the artificial intelligence utilized is either machine learning, deep learning or neural networks.

3. The method of claim 1,
wherein the artificial intelligence model utilizes a natural language understanding and probabilistic models.

4. The method of claim 1,
wherein the language model may be either a large language model or a small language model.

5. The method of claim 1,
wherein additional dimensions by which possible hotels are generated include Structured Hotel Attributes (see appendix Hotel Attributes) :
guest type, as in adult or child;
number of beds;
room class, as in standard, premium, or luxury class.

6. The method of claim 1,
wherein additional dimensions by which possible hotels are generated include Structured Hotel Attributes (see appendix Hotel Attributes):
ability to get a partial refund,
ability to get a full refund,
ability to choose a view,
time of check-in,
time of check-out;
whether breakfast is included;
whether the user is paying in cash or using points; and
whether any discounts apply;
unstructured hotel attributes as defined in appendix hotel attributes;
user reviews, floors, location of the rooms within the hotel; and translating user input like kids friendly, family friendly, best for business travel, etc.

7. The method of claim 1, further comprising:
generating at least one additional prompt that differs from the prompt in at least one of the at least one example shot or the query metadata;
inputting at least one additional prompt into the language model;
receiving, from the language model and in response to the at least one additional prompt, at least one respective additional hotel query reflecting the user intention;
scoring the hotel query and the at least one additional hotel query; and
selecting a top scoring hotel query from among the all possibly generated hotels.

8. The method of claim 1, further comprising:
sampling a prior probability distribution of the trained machine learning model to generate sampled prior probability distributions for the prompt and the at least one additional prompt; and
using the sampled prior probability distributions as parameters of the trained machine learning model in generating the query metadata and selecting the example shots for the prompt and the at least one additional prompt.

9. The method of claim 1, further comprising:
wherein the set of possible hotels that is best match to the hotel query includes structured and unstructured hotel attributes defined in Appendix – Hotel Attributes; user data of a user’s hotel preferences, external context, as well as hotel preferences based on metadata of that user, such as location of the user, time of the hotel travel query, income level, hotel location, and hotel availability and many variables relating to hotels.

10. The method of claim 1, further comprising:
wherein synthetic data is generated using a synthesizer build; and
wherein the synthetic data is utilized to train the machine learning model.

11. The method of claim 1, further comprising:
wherein training data is from all available hotels from a city of the hotel query, including but not limited to (see appendix Hotel Attributes for complete list) guest type, as in adult or child; number of beds; nearby airports; room class, as in standard, premium, or luxury class; ability to get a partial refund; ability to get a full refund; ability to choose a view; time of check-in; time of check-out; whether breakfast is included; whether the user is paying in cash or using points; whether any discounts apply; user data of a user’s hotel preferences, as well as hotel preferences based on metadata of that user, such as location of the user, time of the hotel travel query, income level, hotel location, and hotel availability and many variables relating to hotels; and surrounding cities from the city of the hotel query.

12. The method of claim 1, further comprising:
wherein training data is from all available searches of hotels conducted by the user.

13. The method of claim 1, further comprising:
wherein training data is from synthetic data that is based on:
wherein training data is from all available hotels from a city of the hotel query, including surrounding cities from the city of the hotel query; and
all available searches of hotels conducted by the user.

14. A computer-implemented method to plan to book hotels utilizing artificial intelligence from unstructured user input with a large language model (LLM), the method comprising:
receiving, at a computer system, an input hotel query reflecting a user intention;
wherein a machine learning model has been trained based on user data of a user’s hotel preferences, as well as hotel preferences based on metadata of that user, such as location of the user, time of the hotel query, income level, location of the hotel, and many variables relating to hotels;
analyzing the input hotel query using the trained machine learning model;
generating possible hotels in terms of dates, guest type, as in adult or child; number of beds; nearby airports; room class, as in standard, premium, or luxury class; ability to get a partial refund; ability to get a full refund; ability to choose a view; time of check-in; time of check-out; whether breakfast is included; whether the user is paying in cash or using points; whether any discounts apply; user data of a user’s hotel preferences, as well as hotel preferences based on metadata of that user, such as location of the user, time of the hotel travel query, income level, hotel location, and hotel availability and many variables relating to hotels; based on the input hotel query and the user’s hotel preferences; wherein the machine learning model utilizes a natural language understanding and probabilistic model;
wherein artificial intelligence to understand the user intent is to find the best semantic matches to the user input, external context, hotel attributes and the available hotel inventory; and
wherein training data is from all available hotels from a city of the hotel query, including surrounding cities from the city of the hotel query and from all available searches of hotels conducted by the user.

15. The method of claim 14,
wherein additional dimensions by which possible hotels are generated include:
guest type, as in adult or child;
number of beds;
room class, as in standard, premium, or luxury class.

16. The method of claim 14,
wherein additional dimensions by which possible hotels are generated include:
ability to get a partial refund,
ability to get a full refund,
ability to choose a view,
time of check-in,
time of check-out;
whether breakfast is included;
whether the user is paying in cash or using points; and
whether any discounts apply;
amenities and other semantic similarities to the user request;
user reviews, floors, location of the rooms within the hotel; and translating user input like kids friendly, family friendly, best for business travel, etc. (see complete list in Unstructured Hotel Attributes in appendix hotel attributes).

17. A computer-implemented system to plan to book hotels utilizing artificial intelligence from unstructured user input with a small language model (“SLM”), the method comprising:
receiving, at a computer system, an input hotel query reflecting a user intention;
wherein a machine learning model has been trained based on user data of a user’s hotel preferences, as well as hotel preferences based on metadata of that user, such as location of the user, time of the hotel query, income level, hotel location, and hotel availability and many variables relating to hotels;
analyzing the input hotel query using the trained machine learning model;
generating possible hotels in terms of dates, based on the input hotel query, external context, hotel attributes and the user’s hotel preferences; and
wherein the machine learning model utilizes a natural language understanding and probabilistic model.

18. The system of claim 17,
wherein additional dimensions by which possible hotels are generated include:
guest type, as in adult or child;
number of beds;
room class, as in standard, premium, or luxury class.

19. The system of claim 17,
wherein additional dimensions by which possible hotels are generated include:
ability to get a partial refund,
ability to get a full refund,
ability to choose a view,
time of check-in,
time of check-out;
whether breakfast is included;
whether the user is paying in cash or using points; and
whether any discounts apply;
amenities and other semantic similarities to the user request;
user reviews, floors, location of the rooms within the hotel; and
translating user input like kids friendly, family friendly, best for business travel, etc. (see complete list in Unstructured Hotel Attributes in appendix hotel attributes).

20. The system of claim 17, further comprising:
wherein training data is from synthetic data that is based on:
all available hotels from a city of the hotel query, including surrounding cities from the city of the hotel query; and
all available searches of hotels conducted by the user.
